(19) United States
(12) Patent Application Publication
(10) Pub. No.: US 2003/0148841 A1
(43) Pub. Date: Aug. 7, 2003

(54) Roller chain bushing

(76) Inventor: Bruce E. Gelb, Pleasant Lake, MI (US)

Correspondence Address: Todd L. Moore, Suite 624, 3001 West Big Beaver Road, Troy, MI, 48084, US

(21) Appl. No.: 10/072,686

(22) Filed: Feb. 7, 2002

(51) Int. Cl. F16G 13/02

(52) U.S. Cl. 474/231; 474/230; 474/228

(57) ABSTRACT

A substantially cylindrical bushing for a roller chain formed from a substantially parallelogram blank wherein the lateral sides of the blank are obliquely related to the ends of the blank such that rolling of the blank to form the cylindrical bushing results in a helical bushing seam line. The helical bushing seam line provides improved joint wear and bushing endurance, reduced socket wear, smoother chain and socket engagement, reduced vibration and noise levels, and a reduced need for seam orientation during assembly.

### FIELD OF THE INVENTION

The invention pertains to bushings for roller chains, and in particular, a bushing formed from a blank having a substantially parallelogram configuration, which when rolled into a substantially cylindrical bushing, provides a seam having a helical configuration extending the length of the bushing.

### DESCRIPTION OF THE RELATED ART

Roller chains are commonly and extensively used in the power transmission and conveyor fields. Conventional roller chains include spaced sets of links interconnected by pins, wherein each of the pins support a substantially cylindrical bushing.

Roller chains may or nay not include a roller over the bushing. Roller chains provide a roller mounted upon each of the bushings for engagement with the teeth of a chain sprocket. Roller chains without a roller are called “rollerless” or “bushed” chains. Rollerless or bushed chains allow the bushing to engage the teeth of a chain sprocket directly, without the buffer of a roller, thereby applying a greater amount of stress and wear to the bushing as compared to the roller chain.

Bushings are commonly formed from a rectangular metal blank having substantially parallel ends and substantially parallel lateral sides substantially perpendicular to the ends of the blank. Rolling of the blank in a direction transverse to its length and substantially parallel to the ends results in substantial engagement of the lateral sides of the blank to define a seam extending the length of the bushing. The blank seam is substantially perpendicular to the ends of the bushing and substantially parallel to the longitudinal axis of the bushing. Such conventionally formed bushings have a number of disadvantages due to the presence of the bushing seam. For instance, the seam permits wear and elongation of the chain over extended periods of use. Further, the presence of the seam may cause vibration in the bushing which may lead to the cracking of the bushing. The vibration imposed upon the chain by the bushing seam may also produce fatigue failures in the chain and its components as well as excessive noise. Although not mandatory, the presence of conventional bushing seams also encourages bushing seam orientation when assembling the roller chain.

It would be desirable to provide a bushing for roller chains which is rolled into its final configuration such that the bushing seam is of a helical configuration to provide improved joint wear and bushing endurance, reduced socket wear, smoother chain and socket engagement, reduced vibration and noise levels, and a reduced need for seam orientation during assembly.

It would be desirable to provide a bushing for roller chains wherein the bushing seam is of a helical configuration thereby producing a seamjoint located at variable radial portions of the bushing to significantly reduce bushing stress occurring adjacent the seam. Yet, it would also be desirable to provide a bushing for roller chains having a helical seam wherein formation of the improved bushing may use substantially the same equipment and forming techniques as used in the production of bushing seams having a linear configuration perpendicularly intersecting the seam ends and substantially parallel to the longitudinal axis of the bushing.

### SUMMARY OF THE INVENTION

In the practice of the invention, an improved roller chain assembly provides a plurality of first and second sets of side links interconnected by pins, and a substantially cylindrical bushing circumscribing each pin. The improvement includes the bushing having a longitudinal axis and a pair of opposite ends each lying in a plane wherein said longitudinal axis is substantially perpendicular to the planes. The bushing provides a seam line that intersect the ends and is obliquely related to the planes of the ends to form a substantially helical configuration.

The bushing is formed of a metal blank having a substantially parallelogram configuration. The metal blank includes substantially parallel opposite ends and lateral sides wherein the lateral sides are substantially parallel to each other and obliquely intersect the ends of the blank. The parallelogram blank is rolled into a substantially cylindrical configuration in the direction of the length of the blank ends. The substantially engaging lateral blank sides define a bushing longitudinal seam which is helically related to the longitudinal axis of the bushing.

### BRIEF DESCRIPTION OF THE DRAWINGS

The aforementioned advantages of the invention will be appreciated from the following description and accompanying drawings wherein:

FIG. 1 is an elevational side view of a typical roller chain, partially in section as taken along Section 1-1 of FIG. 2;

FIG. 2 is a top plan view with respect to FIG. 1 of a typical roller chain partially shown in section along Section 2-2 of FIG. 1;

FIG. 3 is an elevational sectional view taken through a link chain pin along Section 3-3 of FIG. 2, showing the bushing of the present invention and the outer links in elevation;

FIG. 4 is a perspective view of a prior art roller chain bushing;

FIG. 5 is a perspective view of a roller chain bushing of the present invention;

FIG. 6 is a plan view of a sheet metal blank used to form the roller chain bushing of the present invention shown in FIG. 5;

FIG. 7 is a graph illustrating the radial layout of the helical seam of a roller chain bushing in accord with the present invention;

FIG. 8 is a graph illustrating fatigue locations at a roller chain bushing in a bushing constructed in accord with the prior art structure of FIG. 4; and

FIG. 9 is a graph similar to FIG. 8 illustrating the forces occurring at a roller chain bushing seam constructed in accord with the present invention.

### DESCRIPTION OF THE PREFERRED EMBODIMENT

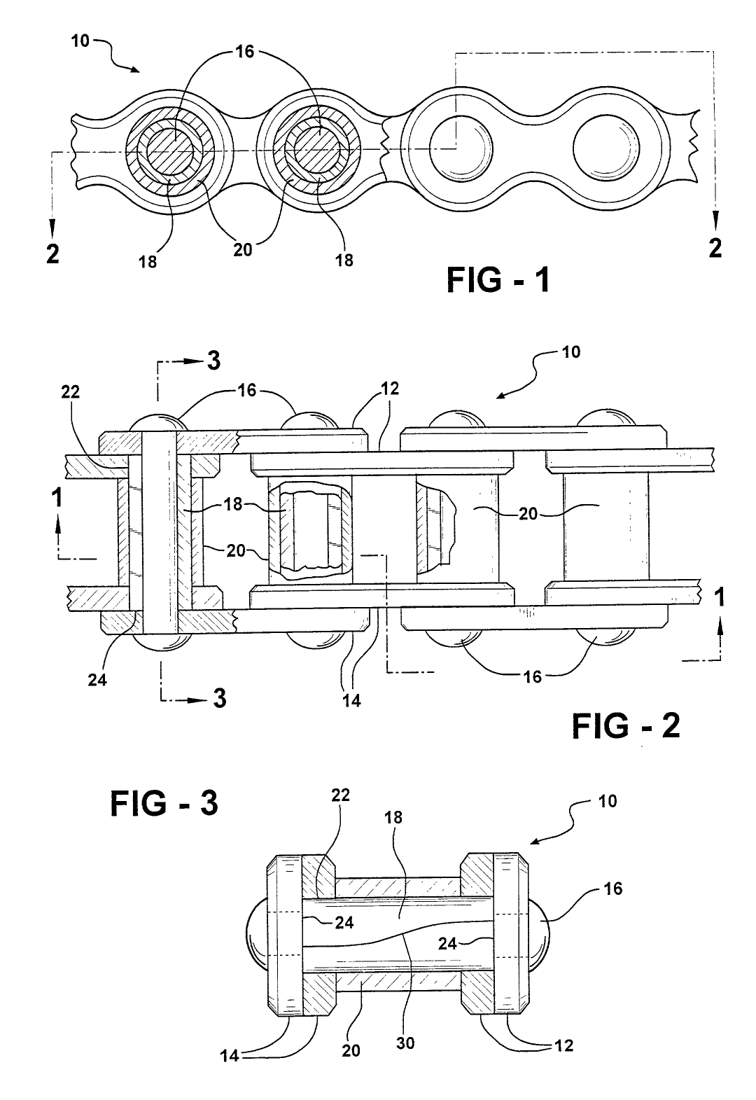

A conventional assembled roller chain using a bushing 18 of the present invention is illustrated in FIGS. 1-3 by the reference numeral 10. It should be noted that the bushing 18 is shown here in conjunction with the roller chain 10 simply for explanatory purposes. The bushing 18 may also be used in rollerless or bushed chains (not shown). Roller and rollerless chains have their advantages and disadvantages, depending on the application, but the bushing 18 of the present invention may be used in either application. As seen in FIGS. 1-3, the roller chain 10 includes side sets of interconnected side links, one set being identified by the reference numeral 12, and the other set being identified by reference numeral 14. The sets of side links 12, 14 are interconnected by headed pins 16, and the pins 16 are located within the substantially cylindrical roller chain bushings 18. Rollers 20 circumscribe the bushings 18, and the bushings 18 are located within the link holes 22, as appreciated from FIGS. 2 and 3.

The bushing 18 is formed from a substantially flat, planar blank 21 fabricated from a rigid metallic material, such as a ferrous alloy or low to medium carbon steel, as seen in FIG. 6. The blank 21 has a substantially parallelogram configuration defined by a pair of opposite and substantially parallel ends 24 and a pair of opposite and substantially parallel, lateral sides 26. The lateral sides 26 meet with the ends 24 of the blank 21 at an oblique angle 23, such as 12 degrees. The present invention is not limited to the oblique angle 23 being a 12 degree angle, but rather the inventor is simply familiar with the 12 degree angle due to the inventor's developmental work on the present invention. The blank 21 is rolled in a direction transverse to its length and substantially parallel to a pair of planes established by the ends 24 of the blank 21. The lateral sides 26 are rolled adjacent one another in substantial engagement to form a seam 30 along the bushing 18. The seam 30 takes the shape of a helix substantially parallel to a longitudinal axis 25 of bushing 18.

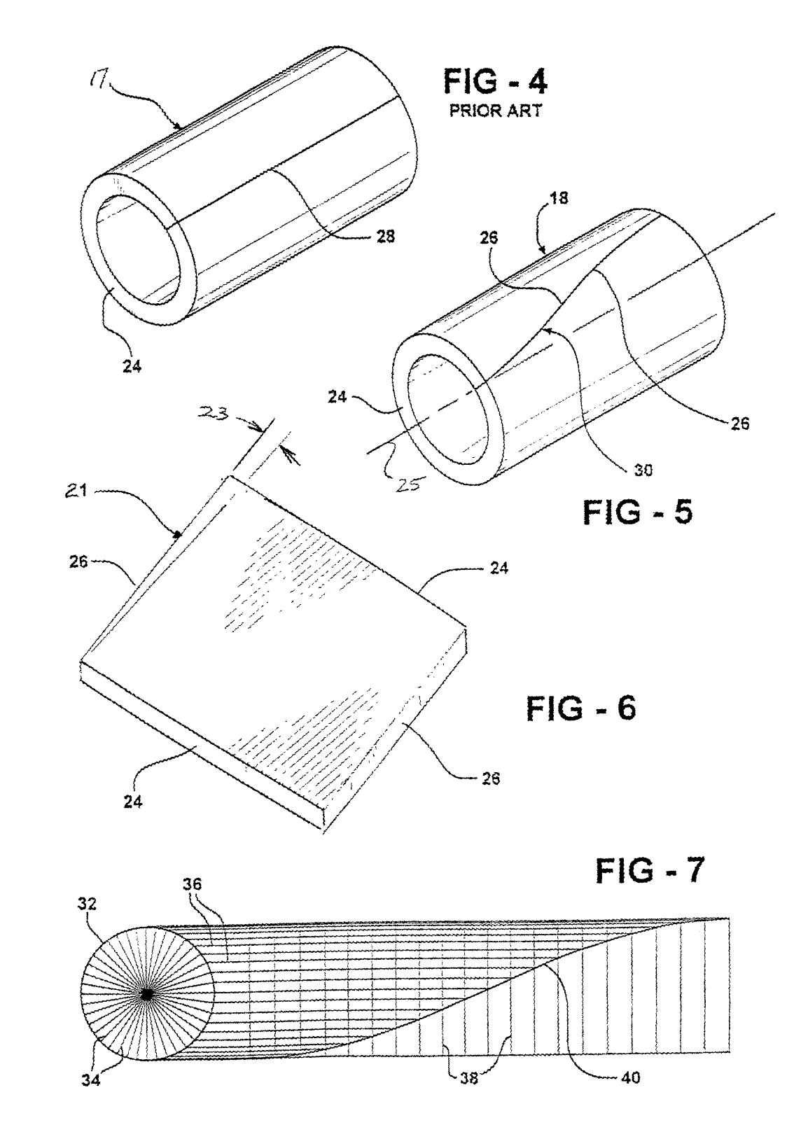

With reference to FIG. 4, a prior art bushing 17 is illustrated having lateral sides substantially perpendicular to the ends 24 of the bushing 17 so that the seam 28 perpendicularly intersects the ends 24 of the bushing 17 and is substantially parallel to the longitudinal axis 25 of the bushing 17.

The roller chain bushing 18 formed in accord with the present invention, as shown in FIG. 5, provides the seam 30 with a helical configuration by using the oblique angle 23 of the lateral sides 26, as formed by the relationships shown in FIG. 7. In FIG. 7, a circle 32 is divided into a plurality of equally spaced radii 34, and the intersection of the radii 34 with the circle 32 is linearly projected to the right, as indicated by lines 36. The lines 36 intersect the equally spaced lines 38 representing equal axial distances on the bushing 18, and the helix 40 representing seam 30 passes through the intersection of the projections 36 with the lines 38.

The helical orientation of the seam 30 reduces the wear at the seam 30, as compared with the linear type of seam 28 shown in FIG. 4, and reduces the elongation of the roller chain 10 due to wear, as compared to when the bushings 28 of the type in FIG. 4 are used. Sprocket wear is also reduced when the bushing 18 of the present invention is utilized on rollerless chains because a smoother chain/sprocket engagement is produced, thereby reducing the vibration experienced in the drive system. The helical bushing seam 30 provides improved bushing retention to the inside chain bar, and the reduction in vibration also reduces the chain drive system noise level. Further, the helical bushing seam 30 reduces the need for orientating the bushing seam 30 with respect to the pins 16 as is often desired when utilizing the prior art bushings 17 of FIG. 4.

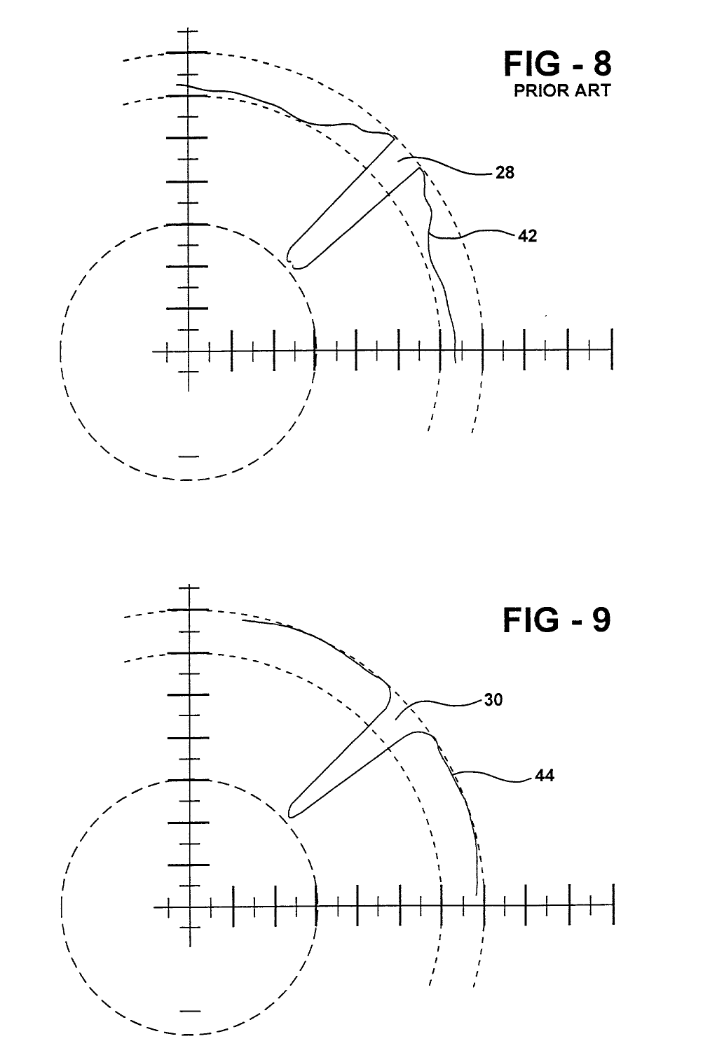

Fatigue resistance of the bushing 18 is also improved as illustrated in the graphs of FIGS. 8 and 9. FIG. 8 represents the prior art forces and fatigue values at 42 adjacent the seam 28, and it will be appreciated that these fatigue forces are not uniform as the resistance to fatigue varies and is non-uniform in a circumferential direction. Conversely, as represented in FIG. 9, the fatigue forces as represented by line 44 of the bushing 18 utilizing the helical seam 30 provides maximum resistance to fatigue in a circumferential direction adjacent the seam 30, and a uniform resistance to fatigue is produced in the circumferential direction of the bushing 18.

It is appreciated that the helical configuration of the bushing seam 30 provides unobvious advantages over the prior art bushing seam 28 orientation as shown in FIG. 4, and various modifications to the inventive concepts may be apparent to those skilled in the art without departing from the spirit and scope of the invention.

1. An improved roller chain assembly having a plurality of first and second sets of side links interconnected by pins and a substantially cylindrical bushing circumscribing each pin, the improvement comprising:
said bushing having a longitudinal axis and a pair of opposite ends each lying in a plane wherein said longitudinal axis is substantially perpendicular to said planes; and
said bushing having a seam line intersecting said ends and obliquely related to said planes of said ends.

2. The improved roller chain assembly stated in claim 1, further comprising:
said seam line having a helical configuration.

3. The improved roller chain assembly stated in claim 1, further comprising:
said bushing fabricated from a metallic material.

4. The improved roller chain assembly stated in claim 1, further comprising:
said bushing fabricated from a substantially planar blank having a substantially parallelogram configuration defined by said ends and a pair of lateral sides wherein said lateral sides substantially engage one another to form said seam line.

5. The improved roller chain assembly stated in claim 4 further comprising:
said ends and said lateral sides of said parallelogram forming a substantially 12 degree angle.

6. A method of forming a roller chain bushing from a substantially planar blank, wherein said blank is defined by a pair of opposite ends and lateral sides, the steps comprising:
forming said ends substantially perpendicular to a longitudinal axis of said blank;
forming said lateral sides parallel to each other and obliquely to said ends; and
creating a blank of a substantially parallelogram configuration and then rolling the blank in a direction parallel to said ends so that said lateral sides substantially engage one another to form a substantially cylindrical roller chain bushing having a helically configured seam line defined by said lateral sides.

7. The method of forming a roller chain bushing stated in claim 6, the steps further comprising:
fabricating said blank from a metallic material.

8. The method of forming a link chain bushing stated in claim 6, the steps further comprising:
establishing a 12 degree angle between said ends and said lateral sides.
